(19) United States
(12) Patent Application Publication
(10) Pub. No.: US 2019/0026738 A1
(43) Pub. Date: Jan. 24, 2019

(54) Systems and Methods for Use in Imposing Secondary Authorizations for Transactions

(71) Applicant: MASTERCARD INTERNATIONAL INCORPORATED, Purchase, NY (US)

(72) Inventors: Erica Joann Robeen, Hardin, IL (US); Shijia Wang, Lake St. Louis, MO (US)

(21) Appl. No.: 15/653,121

(22) Filed: Jul. 18, 2017

(51) Int. Cl. G06Q 20/40

(52) U.S. Cl. CPC G06Q 20/401

(57) ABSTRACT

Systems and methods are provided for use in imposing a secondary authorization for network transactions. One exemplary method includes intercepting a request for a transaction to an account, when an account number included in the request and associated with the account is included in a secondary authorization data structure. The account is associated with a user involved in the transaction. The method further includes identifying a steward for the user from the secondary authorization data structure, transmitting a secondary request to the steward, at a communication device associated with the steward, based on contact information for the steward identified in the secondary authorization data structure, and permitting the request to proceed to an entity associated with the account when a response, from the steward, to the secondary request includes an approval for the transaction.

### FIELD

The present disclosure generally relates to systems and methods for use in imposing secondary authorizations on network transactions, and in particular, to systems and methods for imposing secondary authorizations from stewards for transactions to accounts associated with users.

### BACKGROUND

This section provides background information related to the present disclosure which is not necessarily prior art.

Payment accounts are known to be used by consumers to fund transactions for products (e.g., goods and services, etc.) from a variety of different merchants. In connection therewith, the merchants seek authorization for the transactions from issuers associated with the payment accounts. In general, the authorization relates to the standing of the payment accounts, fraud prevention, and/or whether sufficient funds and/or credit exist to cover the transactions. If authorized by the issuers, the transactions are permitted to proceed, with the consumers receiving the products from the merchants. In addition to authorization, it is known for certain payment accounts to include controls associated with the payment accounts, which, for example, enable notifications to payment account holders when purchases to the payment accounts exceed certain amounts, or when purchases are made with Internet merchants.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in imposing secondary authorizations for payment account transactions;

FIG. 2 is a block diagram of a computing device that may be used in the exemplary system of FIG. 1; and

FIG. 3 is an exemplary method, which may be implemented in connection with the system of FIG. 1, for imposing, by a steward, secondary authorization for a payment account transaction by a consumer when the payment account involved in the transaction is registered for such secondary authorization.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Payment accounts are used by consumers to fund transactions for the purchase of products. Often, the payment accounts issued to the consumers include funds and/or credit, which limit spending of the consumers with the payment accounts. Issuers of the payment accounts impose such limitations through authorization of individual transactions to the payment accounts. For certain consumers, such as those with medical conditions (or other limitations on capacity), additional limitations are useful to inhibit improper, unnecessary, and/or unwise transactions funded by their payment accounts. Uniquely, the systems and methods herein permit consumers (or other persons associated therewith) to impose secondary authorizations, by stewards, of transactions to payment accounts associated with the consumers. In particular, when desired, a payment account is registered for secondary authorization, which causes transactions to the payment accounts to be intercepted in route to an issuer of the payment account (e.g., for all transactions, or based on an amount and/or type of the transactions, etc.). Once intercepted, an authorization engine requests permission from a steward associated with the payment account. If approved, by the steward, the transaction is released, thereby permitting the transaction to proceed to the issuer and be authorized by the issuer (if appropriate). If not approved, by the steward, the authorization engine causes the transaction to be declined (without proceeding to the issuer). In this manner, the consumer is able to improve secondary authorization on purchase transactions to his/her payment account, whereby the steward has to provide the authorizations for the transactions to proceed. As such, the consumer is afforded additional protections against improper, unnecessary, and/or unwise transactions.

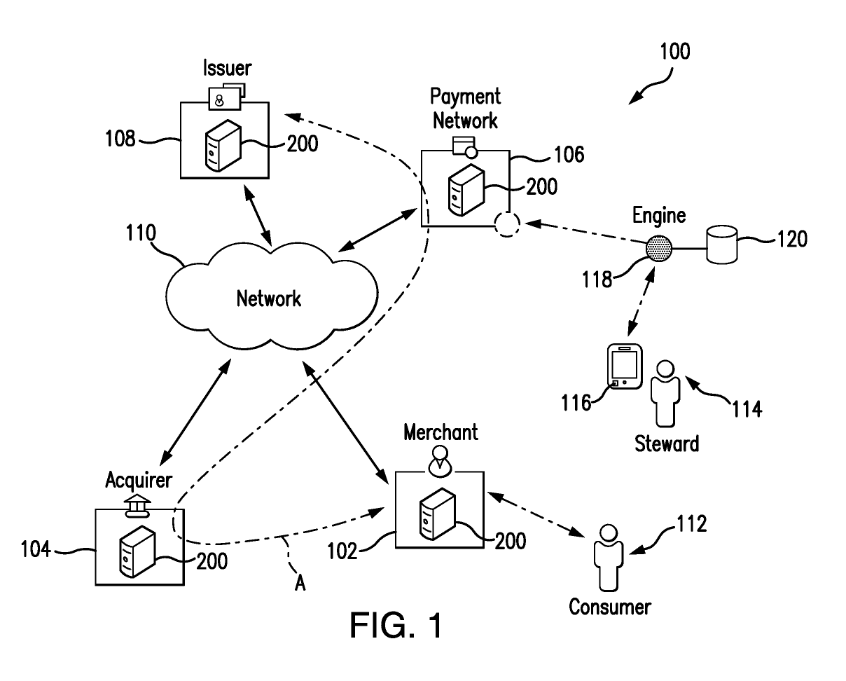

FIG. 1 illustrates an exemplary system 100, in which the one or more aspects of the present disclosure may be implemented. Although the system 100 is presented in one arrangement, other embodiments may include the parts of the system 100 (or other parts) arranged otherwise depending on, for example, processing of purchase transactions, stewards involved in secondary authorization of purchase transactions, manners of seeking permissions from stewards, etc.

The system 100 generally includes a merchant 102, an acquirer 104, a payment network 106, and an issuer 108, each coupled to (and in communication with) network 110. The network 110 may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, network 110 may include multiple different networks, such as a private payment transaction network made accessible by the payment network 106 to the acquirer 104 and the issuer 108 and, separately, the public Internet, which may provide interconnection between one or more of the merchant 102, the payment network 106, and the issuer 108, etc.

Generally in the system 100, the merchant 102 is associated with products (e.g., goods, services, etc.), which are offered for sale and are sold to consumers, including, for example, consumer 112. The merchant 102 may offer the products for sale in physical locations or through websites, or through other internet-based store fronts, as desired. It should be appreciated that, while only one merchant 102 and one consumer 112 are illustrated in FIG. 1, for ease of reference, multiple merchants and/or consumers may be added in the system 100, whereby there may be many different consumers purchasing products at a variety of different merchants.

Also in the system 100, the consumer 112 is associated with a payment account issued by the issuer 108. The payment account may include, without limitation, a credit account, a debit account, a prepaid account, etc. In addition, the system 100 includes a secondary steward 114 for the consumer 112. The steward 114 may include, for example, a parent, a guardian, a trusted advisor or agent, etc. In general, the steward 114 is a person in which the consumer 112, by choice or commitment, intends to entrust a supervisory role as to payment account transactions (broadly, network transactions) to the payment account, through the disclosure herein. In addition, the steward 114 is associated with a communication device 116. In this exemplary embodiment, the communication device 116 is a portable communication device, such as, for example, a smartphone, a tablet, a laptop, etc. The communication device 116 may include, or may be associated with, a network-based payment application (e.g., as a stand-alone application, or as a part of another application, on a mobile operating system or the like (e.g., an e-wallet payment application, an SMS message application, etc.); etc.).

While one merchant 102, one acquirer 104, one payment network 106, and one issuer 108 are illustrated in FIG. 1, it should be appreciated that any number of these entities (and their associated components) may be included in the system 100, or may be included as a part of systems in other embodiments, consistent with the present disclosure. In addition, while one steward 114 is illustrated as associated with the consumer 112, it should be appreciated that multiple different stewards may be associated with the consumer 112 in connection with the present disclosure, where different ones of the multiple stewards may be involved in a supervisory role as to payment account transactions to the payment account by the consumer 112 (e.g., either in a combined supervisory role where the multiple stewards each review payment account transactions and authorization is required from at least one, or from all, of the stewards; or in a divided role where different ones of the multiple stewards are responsible for different payment account transactions; etc.). In connection therewith, in one exemplary embodiment, the steward 114 may be a primary steward as to payment account transactions to the payment account by the consumer 112, with the system 100 then including at least one secondary steward similarly associated with the consumer 112 as to payment account transactions to the consumer's payment account whereby if the primary steward 114 does not respond within a certain period of time then the at least one secondary steward may be contacted as a “backup” for authorization (independent of merchant, item being purchased, purchase price, etc.).

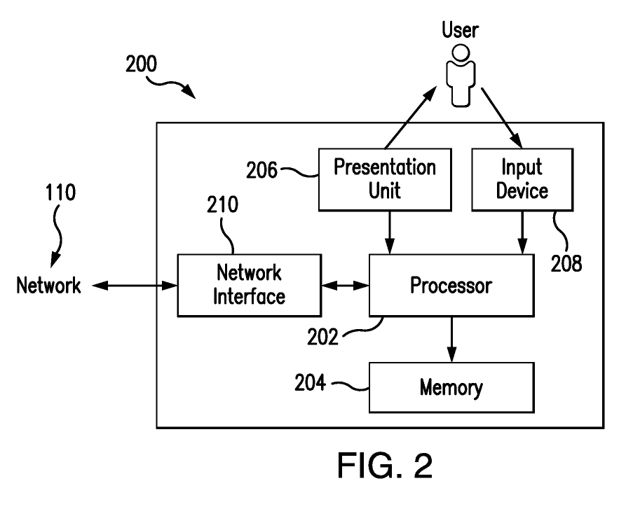

FIG. 2 illustrates an exemplary computing device 200 that can be used in the system 100. The computing device 200 may include, for example, one or more servers, workstations, personal computers, laptops, tablets, smartphones, PDAs, other communication devices, point-of-sale devices, etc. In addition, the computing device 200 may include a single computing device, or it may include multiple computing devices located in close proximity or distributed over a geographic region, so long as the computing devices are specifically configured to function as described herein. In the exemplary embodiment of FIG. 1, each of the merchant 102, the acquirer 104, the payment network 106, and the issuer 108 are illustrated as including, or being implemented in, computing device 200, coupled to (and in communication with) the network 110. In addition, the communication device 116, which is associated with the steward 114, can also be considered a computing device consistent with computing device 200 for purposes of the description herein. However, the system 100 should not be considered to be limited to the computing device 200, as described below, as different computing devices and/or arrangements of computing devices may be used. In addition, different components and/or arrangements of components may be used in other computing devices.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, transaction data, secondary authorization entries, contact information, payment account numbers (e.g., primary account numbers (PANs), etc.), names, and/or other types of data (and/or data structures) suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 that is performing one or more of the various operations herein.

In the exemplary embodiment, the computing device 200 also includes a presentation unit 206 that is coupled to (and is in communication with) the processor 202 (however, it should be appreciated that the computing device 200 could include output devices other than the presentation unit 206, etc.). The presentation unit 206 outputs information (e.g., requests, etc.), visually, for example, to a user of the computing device (e.g., the steward 114 at the communication device 116, etc.). It should be further appreciated that various interfaces (e.g., as defined by operating system-based applications (e.g., conventional operating systems, mobile operating systems, etc.), web-based applications, websites, etc.) may be displayed at computing device 200, and in particular at presentation unit 206, to display certain information. The presentation unit 206 may include, without limitation, a liquid crystal display (LCD), a light-emitting diode (LED) display, an organic LED (OLED) display, an “electronic ink” display, speakers, etc. In some embodiments, presentation unit 206 includes multiple devices.

In addition, the computing device 200 includes an input device 208 that receives inputs from a user (e.g., from the consumer 112, the steward 114, etc.) such as, for example, registration inputs, response inputs (e.g., approval inputs, decline inputs, etc.), etc. The input device 208 may include a single input device or multiple input devices. Moreover, the input device 208 is coupled to (and is in communication with) the processor 202 and may include, for example, one or more of a keyboard, a pointing device, a mouse, a stylus, a scanner, a touch sensitive panel (e.g., a touch pad or a touch screen, etc.), another computing device, and/or an audio input device. In various exemplary embodiments, a touch screen, such as that included in a tablet, a smartphone, or similar device, behaves as both a presentation unit 206 and an input device 208.

Further, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to one or more different networks, including the network 110. In some exemplary embodiments, the computing device 200 includes the processor 202 and one or more network interfaces incorporated into or with the processor 202.

Referring again to FIG. 1, the system 100 includes a secondary authorization engine 118 specifically configured, by executable instructions, to perform one or more of the operations described herein. The secondary authorization engine 118 is illustrated as being a standalone component of FIG. 1, yet, as indicated by the dotted line, may be incorporated with the payment network 106. In connection therewith, the secondary authorization engine 118 may be considered a computing device consistent with computing device 200. It should be appreciated, however, that the secondary authorization engine 118 may be associated with, or incorporated in, other parts of the system 100 (e.g., the issuer 108, etc.) or other parts in general (not shown in FIG. 1), in other embodiments.

In addition, the system 100 includes a secondary authorization data structure 120, which is configured, according to known data storage schemes, to store secondary authorization entries for payment accounts. The secondary authorization data structure 120 is generally associated with the secondary authorization engine 118, and as such, is likely incorporated with the secondary authorization engine 118. That said, the secondary authorization data structure 120 may be situated otherwise, as appropriate and/or as needed. Regardless of association, the secondary authorization engine 118 is generally permitted and able to access the data structure 120 in order to perform the operations described herein.

When desired and/or required to do so, to implement the various features herein, the consumer 112 accesses the secondary authorization engine 118, for example, via a network-based application, etc., to register his/her payment account. In particular, in connection with registering the payment account, the secondary authorization engine 118 is configured to cause one or more interfaces to be displayed to the consumer, for example, at a computing device associated with the consumer 112. Upon verification of the consumer 112 (e.g., via a login, via another authentication operation, etc.), the secondary authorization engine 118 may be configured, if not acquired based on the verification of the consumer 112, to then solicit payment account details for the consumer's payment account, such as, for example, the primary account number (PAN), etc. (e.g., via the one or more interfaces, etc.). The secondary authorization engine 118 may also be configured to solicit from the consumer 112 information for the steward 114 (e.g., the steward's name, a relation of the steward 114 with the consumer 112, contact information for the steward 114 (e.g., phone number, email address, etc.), etc.) (e.g., again via the one or more interfaces, etc.). The secondary authorization engine 118 is configured to further solicit an activation of the secondary authorization for the consumer's payment account, i.e., an activation setting. Moreover, the secondary authorization engine 118 is configured to store a secondary authorization entry in the data structure 120, which includes the PAN for the consumer's payment account and the activation setting, and any other relevant and/or desired data regarding the consumer 112, the consumer's payment account, the steward 114 as identified by the consumer 112, and/or the desired secondary authorization.

Similarly, when desired and/or appropriate, the secondary authorization engine 118 is configured to solicit a deactivation setting for the consumer's payment account, for example, when the secondary authorization of payment account transactions to the payment account is no longer desired, necessary, etc. Such deactivation setting may simply suspend secondary authorization for transactions to the consumer's payment account. Or, the deactivation setting may un-register the consumer 112 and/or the payment account from the secondary authorization engine 118. However, once the consumer 112 is registered for such secondary authorizations, and the steward 114 has confirmed such registration (as described next), any implementation of such deactivation setting and/or any modifications to control of the secondary authorizations (e.g., attempts by the consumer 112 to overwrite control of the secondary authorizations, etc.) will trigger an alert to the steward 114, generally in the manner described below for transaction alerts, etc.

Next in the system 100, once the consumer 112 and/or the consumer's payment account is/are registered, the authorization engine 118 is configured to transmit a verification message (or notification) to the steward 114 (confirming such registration) (e.g., via an SMS message, an email, etc. based on the contact information for the steward 114 provided by the consumer 112; etc.). The verification message may merely include a notice to the steward 114, or may include a link or other direction for the steward 114 to download and/or activate a network-based application at the communication device 116. For example, a network-based application (e.g., MasterPass™ from MasterCard®, a mobile banking application associated with the issuer 108, a standalone application specifically directed to secondary authorizations as described herein, another application, etc.) may permit the authorization engine 118 to communicate with the communication device 116, and the steward 114, whereby the interaction between the steward 114 and the network-based application may be efficient and specific to secondary authorizations of transactions involving the consumer's payment account (e.g., the network-based application may allow for additional ease in parameter control for the secondary authorizations, etc. (e.g., as compared to SMS messaging, etc.)). In connection therewith, if the steward 114 does not have the corresponding network-based application already installed at the communication device 116, the verification message may include an application download suggestion as part of the link and/or direction for the network-based application. In any case, in response to the verification message, the steward 114 may then verify receipt of the message, confirm the corresponding information provided by the consumer 112 about the steward 114, install the network-based application as necessary, and select a preferred method of contact for transaction authorizations/approvals (e.g., SMS messages, emails, pop-up application alerts via the network-based application, etc.). As such, through these registration operations, the consumer 112 generally has insight to the information for the steward 114 as used herein to provide secondary authorization of transactions performed by the consumer 112.

Subsequently, in one transaction example, the consumer 112 may initiate a transaction with the merchant 102, for example, for the purchase of a product, by presenting to the merchant 102 a payment device associated with the consumer's payment account. In turn, the merchant 102 submits an authorization request (broadly, an authorization message) for the transaction to the acquirer 104 (associated with the merchant 102). And, the acquirer 104 attempts to communicate the authorization request to the issuer 108 (associated with the consumer's payment account), through the payment network 106, such as, for example, through MasterCard®, VISA®, Discover®, American Express®, etc., to determine whether the payment account is in good standing and whether there is sufficient funds and/or credit to fund the transaction. In this exemplary embodiment, the authorization request is generally a message consistent with the ISO 8583 standard and is transmitted along path A in the system 100, as referenced in FIG. 1.

In this example transaction, when the secondary authorization is active for the consumer 112, the secondary authorization engine 118 is configured to intercept the authorization request when the PAN (broadly, a parameter) included in the authorization request matches a PAN included in the secondary authorization data structure 120 (e.g., where the authorization request is intercepted along path A, for example, when the authorization request is received at the payment network 106, etc.). In turn, the authorization engine 118 is configured to transmit a request for permission for the transaction to the steward 114, as identified in the data structure 120 for the given payment account (and based on the contact preferences provided by the steward 114. The steward 114 receives the request at the communication device 116 (e.g., via the network-based application, etc.), which is configured to then display the request to the steward 114, accept an input response for the request from the steward 114 (e.g., an approval input, a decline input, etc. based on the application), and transmit the response to the authorization engine 118. In other embodiments, the authorization engine 118 may be configured to intercept the authorization request based on data in the authorization request other than the PAN. For example, the authorization engine 118 may be configured to intercept the authorization request based on other parameters such as merchant type, transaction amount, transaction frequency, etc.

If the response includes a decline, the authorization engine 118 is configured to return a decline to the merchant 102, for example, by way of a 0120 authorization message (as an authorization response, etc.) (e.g., back along path A in FIG. 1). In so doing, the steward 114 generally inhibits the transaction from taking place. In addition, in connection with the decline, the steward 114 may transmit a message to the consumer 112 (e.g., via the network-based application, etc.) providing a reason for the decline (e.g., “The transaction is too expensive,” “The products involved in the transaction are not approved,” “Let's discuss the transaction,” etc.), providing suggestions for alternative transactions, etc.

Conversely, if the response from the steward 114 includes an approval of the transaction, the authorization engine 118 is configured to release the intercepted authorization request to the payment network 106 and the issuer 108, thereby permitting it to proceed in a conventional manner (along path A in FIG. 1, etc.). If the transaction is approved by the issuer 108, an authorization reply (broadly, an authorization message) indicating the approval of the transaction is transmitted back from the issuer 108 to the merchant 102, along path A, thereby permitting the merchant 102 to complete the transaction. The transaction is later cleared and/or settled (via appropriate transaction messages such as clearing messages and/or settlement messages along path A, for example) by and between the merchant 102, the acquirer 104, and the issuer 108 (by appropriate agreements). If the transaction is declined by the issuer 108, however, an authorization reply (broadly, an authorization message) indicating a decline of the transaction is provided back to the merchant 102, along path A, thereby permitting the merchant 102 to halt or terminate the transaction, or request alternate funding.

Transaction data is generated, collected, and stored as part of the above interactions among the merchant 102, the acquirer 104, the payment network 106, the issuer 108, and the consumer 112 (and included in the various transaction messages herein). The transaction data represents at least a plurality of transactions, for example, authorized transactions, cleared and/or settled transactions, attempted transactions, etc. The transaction data, in this exemplary embodiment, is stored at least by the payment network 106 (e.g., in a data structure associated with the payment network 106, etc.). Transaction data, as used herein, may include, for example (and without limitation), PANs for payment accounts involved in the transactions, tokens associated with the payment accounts, amounts of the transactions, merchant IDs, merchant category codes (MCCs), dates/times of the transactions, payment device identifiers (e.g., application IDs, device IDs, etc.), payment/notification application IDs, location IDs, products purchased and related descriptions or identifiers, etc. It should be appreciated that more or less information related to transactions, as part of either authorization, clearing and/or settling, may be included in transaction data and stored within the system 100, at the merchant 102, the acquirer 104, the payment network 106 and/or the issuer 108.

As indicated above, it should again be appreciated that the consumer 112 may be associated with multiple stewards (e.g., the consumer may identify multiple different stewards during registration of his/her payment account for secondary authorizations as described herein, etc.). In connection therewith, different ones of the multiple stewards may be involved in a supervisory role for authorizing/approving, or not, payment account transactions to the consumer's payment account. For example, when the consumer 112 is associated with two different stewards, the consumer 112 and/or the stewards may indicate (e.g., during registration or thereafter, etc.) whether authorization for transactions in general, or for a given transaction, is required by one of the particular stewards, by either one of the stewards, or by both of the stewards. In addition, in some implementations of this example, transactions by the consumer 112 involving particular merchants, involving particular categories of merchants, involving particular products, exceeding a defined amount, etc. may require authorization/approval from a particular one of the stewards, or such transactions may require authorization/approval from both of the stewards (with all other transactions then requiring approval/authorization from either one of the stewards). In some further implementations of this example, authorization for transactions by the consumer 112 may initially be directed to a first one of the stewards, whereby if the first one of the stewards does not respond within a certain period of time then a second one of the stewards may be contacted as a “backup” for authorization (independent of merchant, item being purchased, purchase price, etc.).

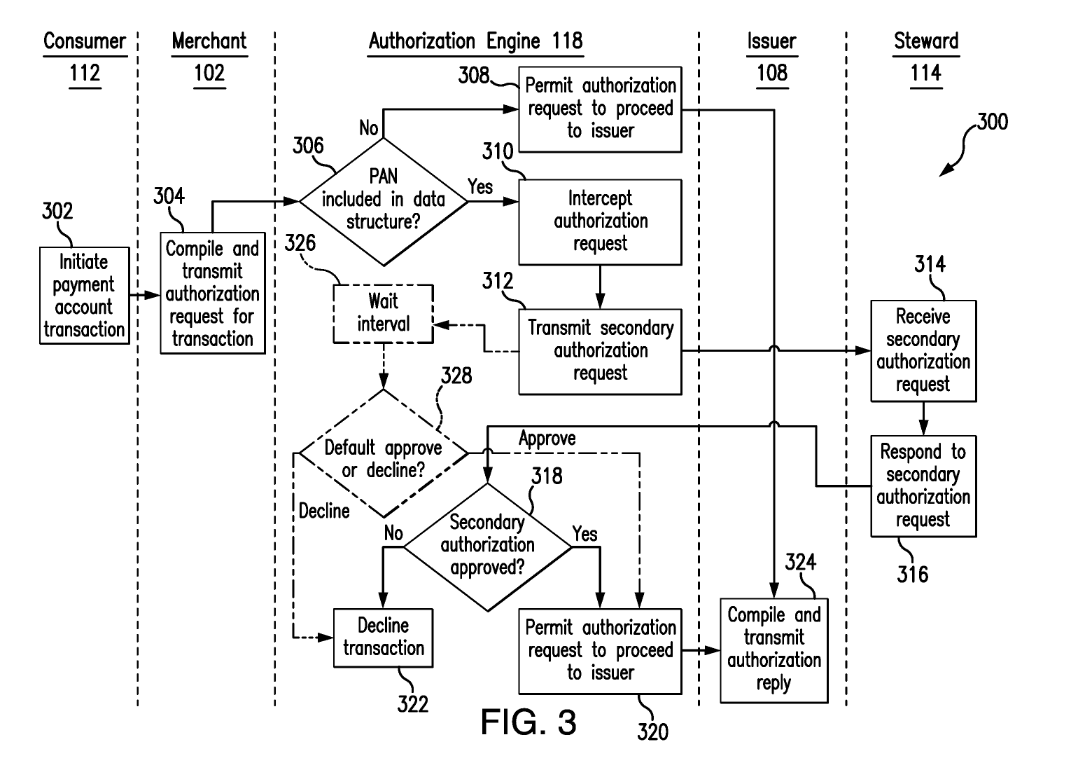

FIG. 3 illustrates an exemplary method 300 for imposing a secondary authorization, by a steward, on a payment account transaction to a payment account associated with a consumer (where the consumer is an individual other than the steward). The exemplary method 300 is described with respect to interactions among the merchant 102, the payment network 106, the consumer 112, the steward 114, the secondary authorization engine 118, and the secondary authorization data structure 120 of the system 100. In addition, the method 300 is also described with reference to the computing device 200. The methods herein (including the method 300), however, should not be understood to be limited to the exemplary system 100 or the exemplary computing device 200. And, likewise, the systems and the computing devices herein should not be understood to be limited to the exemplary method 300.

At 302 in the method 300, the consumer 112 initiates a payment account transaction, for example, by presenting a payment device associated with his/her payment account to the merchant 102. In response, at 304, the merchant 102, and in particular a point-of-sale (POS) device associated with the merchant 102, compiles an authorization request for the transaction and transmits the authorization request to the acquirer 104 and payment network 106. In this exemplary embodiment, the POS terminal compiles and transmits the authorization request as an authorization message consistent with the ISO 8583 standard, and in particular, for example, as an 0100 authorization request message. The authorization request then includes, without limitation, a name of the consumer 112, a name of the merchant 102, a merchant ID, a transaction amount, a PAN for the consumer's payment account, expiration data for the consumer's payment account, a card verification code (CVC) for the consumer's payment account, a merchant category code (MCC), a region code for the merchant 102 and/or the transaction, a transaction type indicator, etc. It should be appreciated that more, the same, or different data may be included in a variety of different authorization requests as contemplated herein.

As the authorization request reaches the payment network 106, in this exemplary method 300 (and depending on the location of the secondary authorization engine 118 in the system 100, etc.), the secondary authorization engine 118 determines, at 306, if the PAN included in the authorization request (and associated with the consumer's payment account) matches a PAN listed in the secondary authorization data structure 120 (i.e., matches a PAN for a payment account registered to the secondary authorization engine 118). If it does not, the authorization engine 118 permits, at 308, the authorization request to proceed to/through the payment network 106 and to the issuer 108 (which is the issuer of the consumer's payment account) for conventional processing. Conversely, if the PAN for the consumer's payment account (as used in the example transaction) is included in the secondary authorization data structure 120, the secondary authorization engine 118 intercepts the authorization request, at 310. For example, in the illustrated method 300, intercepting the authorization request may include the authorization engine 118 and/or the payment network 106 (e.g., upon indication from the authorization engine 118, etc.) holding/delaying the authorization request (e.g., at the payment network 106, etc.) for performance of secondary authorization as described herein. Alternatively, in some embodiments, intercepting the authorization request (e.g., at 310 in method 300, etc.) may include the authorization engine 118 permitting the authorization request to proceed to the issuer 108, with the issuer 108 then holding/delaying the authorization request (e.g., upon indication from the authorization engine 118, etc.) for performance of secondary authorization as described herein (e.g., for further instructions from the authorization engine 118 regarding the secondary authorization, etc.). Then, when the secondary authorization includes approval of the transaction, the issuer 108 (e.g., upon notification by the authorization engine 118, etc.) processes the authorization request for the transaction in a conventional manner (e.g., as described above in connection with path A in FIG. 1, etc.). Further, in some embodiments, the authorization engine 118 may instead intercept an authorization reply for the transaction from the issuer 108, when the authorization reply includes an approval of the transaction, and hold/delay the authorization reply at the payment network 106, for example, for performance of the secondary authorization. Then, when the secondary authorization includes approval of the transaction, the payment network 106 (e.g., upon notification by the authorization engine 118, etc.) processes the authorization reply for the transaction in a conventional manner (e.g., as described above in connection with path A in FIG. 1, etc.).

With that said, it should be appreciated that, while the secondary authorization engine 118 relies on the PAN in this embodiment, different data included in the authorization request may be used in other embodiments to determine if a transaction is subject, or not subject, to secondary authorization as described herein. Moreover, apart from merely identifying the payment account, the authorization engine 118 may rely on other/additional data included in the authorization request to determine whether or not the transaction should be subject, or not subject, to secondary authorization. For example, after identifying the payment account, an amount of the transaction may further be compared, by the secondary authorization engine 118, to a defined threshold, with the transaction then being subjected to secondary authorization only when the transaction amount exceeds the defined threshold. That is, a transaction may be subject to secondary authorization when the transaction amount exceeds $15.00 (or other desired amount). In another example, the transaction may be subjected to secondary authorization based on the type of transaction and/or based on the MCC associated with the transaction. Specifically, in one instance, the transaction may be determined, by the authorization engine 118, to be subject to secondary review when the transaction is a card-not-present transaction and/or when the transaction is in MCC 7995 (betting), MCC 7538 (automotive service shops), or MCC 8398 (charitable and social service organizations). As described above, it should be appreciated that various different data included in the authorization request may be used in other examples and/or embodiments (e.g., merchant name, transaction frequency, etc.).

In some implementations of the method 300, while the authorization request is pending with the authorization engine 118 (upon being intercepted, at 310), the authorization engine 118 may (e.g., optionally, etc.) transmit an authorization advise message (e.g., a message based on the ISO 8583 standard, a message based on another format, etc.) to the merchant 102 to inform the merchant 102 and/or the consumer 112 that secondary authorization of the transaction is being sought. In response, the merchant 102 may, at its discretion, provide and/or allow additional time for authorization of the transaction or proceed without such authorization.

With continued reference to FIG. 3, after intercepting the authorization request, the secondary authorization engine 118 transmits, at 312, a permission request for the secondary authorization to the steward 114 (e.g., to the communication device 116 associated with the steward 114, etc.). In particular, by determining that the PAN in the authorization request for the transaction is present in the secondary authorization data structure 120, the secondary authorization engine 118 also locates the registration entry in the data structure 120 associated with the PAN. The entry includes not only the PAN for the consumer's payment account, but also contact information for the steward 114. The contact information may include, for example, a phone number, an email address, an application ID, etc., at which the steward 114 may be reached and/or contacted. The authorization engine 118, then, uses the contact information for the steward 114 to transmit the secondary authorization request, at 312, for example, by sending an SMS message to the steward 114, by initiating a pop-up application alert via the network-based application at the steward's communication device 116 etc. The secondary authorization request will include, in this example, a name of the merchant 102 involved in the transaction (or other merchant identifier), an amount of the transaction, and a manner of responding to either approve or decline the transaction. For example, the message may include “Consumer 112 is attempting a transaction for $57.23 at Merchant 102. Respond with 1234 to approve or 7890 to decline.”

The steward 114, in turn, receives the secondary authorization request, at 314, and then, at 316, responds to the secondary authorization request as appropriate. In the example above, the steward 114 may respond with an SMS message of either “1234” or “7890” to approve or decline the transaction, respectively.

Next, when the secondary authorization engine 118 receives the response from the steward 114, the engine 118 determines, at 318, whether the transaction is approved (or declined) by the steward 114, as the secondary authorization. If the transaction is approved by the steward 114, the secondary authorization engine 118 permits the authorization request to proceed to the payment network 106 and to the issuer 108, at 320 (or transmits such permission to the payment network 106 and/or the issuer 108). Conversely, if the secondary authorization is not approved by the steward 114, the authorization engine 118 causes the transaction to be declined, at 322 (or transmits instructions to decline the transaction to the payment network 106 and/or the issuer 108). When the authorization engine 118 indicates that the transaction is to be declined, based on secondary authorization by the steward 114, the authorization engine 118 (or the payment network 106, or the issuer 108) may compile and transmit a message to the merchant 102, such as, for example, an ISO 8583 0120 message (or other formatted message) declining the transaction (or indicating the decline of the transaction). The merchant 102 is then permitted to halt the transaction, or seek alternate payment for the products desired to be purchased by the consumer 112. In addition, in connection with the decline, the authorization engine 118 may transmit a message to the consumer 112 (e.g., via contact information provided by the consumer 112 during registration for secondary authorization services as described herein, such as via the network-based application at the consumer's communication device, etc.; etc.) indicating that the transaction is declined by the steward 114.

When the authorization request is permitted to proceed (either at 308 or at 320 in the method 300), the issuer 108 receives the authorization request and determines whether to approve or decline the transaction. Then, at 324 in the illustrated method 300, the issuer 108 compiles an authorization reply for the transaction and transmits the authorization reply back through the payment network 106 and the acquirer 104 to the merchant 102, as is generally conventional. In response, if the transaction is approved by the issuer 108 in the authorization reply, the merchant 102 understands the transaction to be finished and permits delivery of the product(s) to the consumer 112. Conversely, if the transaction is declined, the merchant 102 is permitted to halt the transaction, or seek alternate payment for the products desired to be purchased by the merchant 102.

Optionally in the method 300, as indicated by the dotted lines in FIG. 3, after the secondary authorization engine 118 transmits the secondary authorization request to the steward 114, at 312, the authorization engine 118 may wait for an interval, at 326. The interval may include, without limitation, one minute, two minutes, three minutes, 10 minutes, or some other interval. Often, a length of the interval may depend on the type of transaction, such that, for example, an Internet transaction may be given a longer wait interval (e.g., 30 minutes, etc.), while a card present transaction may be given a short wait interval (e.g., two minutes, etc.). Regardless of the length of the interval, after expiration without a response from the steward 114, the secondary authorization engine 118 determines if a default is to approve or decline the transaction, at 328. Such default setting may be provided by the consumer 112 during registration of his/her payment account to the secondary authorization engine 118 (or thereafter), or it may be provided by the steward 114 in connection with such registration (or thereafter), or it may be provided by the authorization engine 118 (as a default for secondary authorization in general), etc. In one example, the default setting (as provided by the consumer 112 during registration of his/her payment account to the secondary authorization engine 118) is a default decline, whereby all transactions not in receipt of a secondary authorization from the steward 114 are declined. In a different example, the default setting is a default approve, whereby all transactions are approved, if not specifically declined by the steward 114, as part of the secondary authorization. In still other embodiment, during registration, the consumer 112 and/or the steward 114 may place conditions on the default setting for approve/decline, whereby transactions under a defined threshold amount may be default approved while transactions at or above that threshold may be default declined. Additionally, or alternatively, the default approve/decline setting may be subject to other conditions, such as those related to transaction types and/or merchant categories, etc.

In view of the above, the systems and methods herein may permit secondary authorization to be imposed on payment account transactions. In this manner, a consumer may designate one or more stewards, or persons trusted by the consumer or those associated with the consumer, so that transactions by the consumer are authorized by the steward(s) in addition to the issuer associated with the payment account. The secondary authorization may be imposed to inhibit the consumer from pursuing improper, unnecessary or unwise purchases. As such, the consumer is afforded additional protection for use of the payment account, through an efficient and improve manner of involving addition persons (i.e., the steward(s)) in decision making related to spending through the payment account.

Again and as previously described, it should be appreciated that the functions described herein, in some embodiments, may be described in computer executable instructions stored on a computer readable media, and executable by one or more processors. The computer readable media is a non-transitory computer readable storage media. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) intercepting an authorization request for a network transaction (e.g., a payment account transaction, etc.) to an account (e.g., a payment account, etc.), when an account number (e.g., a primary account number (PAN), etc.) included in the authorization request and associated with the account is included in a secondary authorization data structure, the account associated with a user (e.g., a consumer, etc.) involved in the transaction; (b) identifying a steward for the user from the secondary authorization data structure, (c) transmitting a secondary authorization request to the steward, at a communication device associated with the steward, based on contact information for the steward identified in the secondary authorization data structure; and (d) routing the authorization request to an entity (e.g., an issuer, etc.) associated with the account when a response, from the steward, to the secondary authorization request includes an approval for the transaction.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

In addition, as used herein, the term product may include a good and/or a service.

As used herein, a token (e.g., a payment token, etc.) generally is an electronic data set that includes credentials that may be used in a purchase transaction in place of traditional payment credentials. Typically, the credentials for the token are uniquely associated to a computing device (e.g., a portable communication device, etc.), for example, to which the token is provisioned. Because the token is directly associated to the computing device, theft of the token may be inconsequential to the user, since the token is unusable if not used in conjunction with the proper computing device. Thus, the use of the token can enable electronic payment transactions involving the computing device with greater security without a sacrifice to efficiency or convenience. The systems and methods herein thus may also include, as appropriate, generating and/or assigning the tokens to consumers and provisioning the tokens to computing devices associated with the consumers.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for imposing a secondary authorization for a network transaction, the method comprising:
intercepting, by a computing device, an authorization request for a transaction to an account, when an account number included in the authorization request and associated with the account is included in a secondary authorization data structure, the account associated with a user involved in the transaction;
identifying, by the computing device, a steward for the user from the secondary authorization data structure;
transmitting a secondary authorization request to the steward, at a communication device associated with the steward, based on contact information for the steward identified in the secondary authorization data structure; and
permitting, by the computing device, the authorization request to proceed when a response, from the steward, to the secondary authorization request includes an approval for the transaction.

2. The method of claim 1, further comprising causing the transaction to be declined when the response, from the steward, to the secondary authorization request includes a decline of the transaction.

3. The method of claim 2, further comprising permitting the authorization request to proceed when no response from the steward is received within a predefined interval.

4. The method of claim 1, further comprising causing the transaction to be declined when no response from the steward is received within a predefined interval.

5. The method of claim 1, wherein transmitting the secondary authorization request to the steward includes transmitting the secondary authorization request to the steward via a network-based application at the communication device associated with the steward.

6. The method of claim 1, further comprising registering the user to the secondary authorization data structure; and
activating, by the computing device, the secondary authorization for the account;
wherein intercepting, by the computing device, the authorization request for the transaction includes intercepting the authorization request for the transaction only when the secondary authorization is active.

7. The method of claim 6, further comprising deactivating the secondary authorization.

8. The method of claim 1, wherein permitting the authorization request to proceed includes permitting the authorization request to proceed to an entity associated with the account.

9. A system for imposing a secondary authorization for a payment account transaction, the system comprising:
at least one memory device including a secondary authorization data structure having at least one entry, the at least one entry associated with a payment account and including contact information for a steward; and
a processor in communication with the at least one memory device, the processor configured to:
determine whether a transaction involves a payment account included in the secondary authorization data structure;
intercept an authorization message associated with the transaction when the transaction involves the payment account included in the secondary authorization data structure;
transmit a secondary authorization request to the steward included in the entry in the secondary authorization data structure for the payment account; and
permit the authorization message to continue toward an issuer associated with the payment account and/or an acquirer associated with a merchant involved in the transaction when a response to the secondary authorization request indicates approval of the transaction by the steward, whereby the steward authorizes the transaction to proceed as desired.

10. The system of claim 9, wherein the processor is further configured to decline the transaction when the response to the secondary authorization request indicates a decline by the steward.

11. The system of claim 10, wherein the processor is configured, in connection with intercepting the authorization message associated with the transaction, to intercept the authorization message when the transaction involves the payment account included in the secondary authorization data structure and an amount of the transaction exceeds a defined threshold.

12. The system of claim 10, wherein the processor is further configured to:
receive data regarding the payment account from a consumer associated with the payment account and store the data in the secondary authorization data structure in the at least one entry associated with the payment account; and
receive the contact information for the steward from the consumer and store the contact information in the secondary authorization data structure in the at least one entry associated with the payment account.

13. The system of claim 12, wherein the processor is further configured, in response to receiving the data regarding the payment account from the consumer, to generate an activation setting for secondary authorization by the steward of transactions involving the payment account and store the activation setting in the secondary authorization data structure in the at least one entry associated with the payment account.

14. The system of claim 13, wherein the processor is further configured to transmit a message to the consumer indicating that the transaction is declined, when the response to the secondary authorization request indicates a decline by the steward.

15. The system of claim 9, wherein the authorization message includes an authorization request directed toward the issuer.

16. The system of claim 9, wherein the processor is further configured to decline the transaction, after a wait interval, when no response is received from the steward.

17. A non-transitory computer-readable storage media including computer-executable instructions for use in imposing a secondary authorization for a payment account transaction, which, when executed by a processor, cause the processor to:
intercept an authorization request for a transaction to a payment account when a primary account number (PAN) included in the authorization request and associated with the payment account is included in a secondary authorization data structure, the payment account associated with a consumer involved in the transaction;
identify a steward for the consumer from the secondary authorization data structure;
transmit a secondary authorization request for the transaction to the steward, prior to approval of the transaction by an issuer associated with the payment account;
permit the authorization request to continue toward the issuer associated with the payment account when a response to the secondary authorization request indicates approval of the transaction by the steward, whereby the steward authorizes the transaction to proceed as desired; and
decline the transaction when the response to the secondary authorization request indicates a decline by the steward, whereby the steward inhibits the transaction from proceeding.

18. The non-transitory computer-readable storage media of claim 17, wherein the computer-executable instructions, when executed by the processor, further cause the processor to register the consumer to the secondary authorization data structure and activate the secondary authorization for the payment account; and
wherein the computer-executable instructions, when executed by the processor, cause the processor, in connection with intercepting the authorization request for the transaction to the payment account, to intercept the authorization request only when the secondary authorization is active.

19. The non-transitory computer-readable storage media of claim 18, wherein the computer-executable instructions, when executed by the processor, cause the processor, in connection with intercepting the authorization request for the transaction to the payment account, to intercept the authorization message when the PAN included in the authorization request is included in the secondary authorization data structure and when:
an amount of the transaction exceeds a predefined threshold; and/or
a merchant category code (MCC) included in the authorization request includes at least one predefined MCC.

20. The non-transitory computer-readable storage media of claim 17, wherein the computer-executable instructions, when executed by the processor, further cause the processor to receive the response to the secondary authorization request from the steward via a network-based application at a communication device associated with the steward.
